(19) United States
(12) Patent Application Publication
(10) Pub. No.: US 2014/0198339 A1
(43) Pub. Date: Jul. 17, 2014

(54) IDENTIFICATION OF A PRINT SERVICE PROVIDER

(71) Applicant: HEWLETT-PACKARD DEVELOPMENT COMPANY, L.P., (US)

(72) Inventors: Sunil Kothari, Palo Alto, CA (US); Ehud Chatow, Palo Alto, CA (US); Ingeborg Tasti, Palo Alto, CA (US)

(73) Assignee: HEWLETT-PACKARD DEVELOPMENT COMPANY, L.P., Houston, TX (US)

(21) Appl. No.: 13/740,976

(22) Filed: Jan. 14, 2013

(51) Int. Cl. G06F 3/12

(52) U.S. Cl. CPC G06F 3/1296
USPC 358/1.15

(57) ABSTRACT

A method comprises receiving an identifier from a user, the identifier being associated with a print object; determining capabilities associated with the print object; identifying a print service provider based on the capabilities; and providing information associated with an identified print service provider to the user.

### BACKGROUND

Print services are entities which can provide a print object that is based on an order from a customer. Various print services may have different capabilities for each step in the production of the print object.

### BRIEF DESCRIPTION OF THE DRAWINGS

For a more complete understanding of various examples, reference is now made to the following descriptions taken in connection with the accompanying drawings in which:

FIG. 1 illustrates an example print object;

FIG. 2 illustrates an example print service system;

FIGS. 3-5 illustrate flowcharts of example processes for providing a print service; and

FIG. 6 illustrates a block diagram of an example device.

### DETAILED DESCRIPTION

Various examples described herein relate to print services. In accordance with various examples, a user may scan an indicator, such as a bar code or a Quick Response (QR) code, associated with a print object. A server may use to code to determine various features of the print object. For example, the server may determine the capabilities that were used or are required to produce the print object. The server may then provide the user with an identification of a print service provider (PSP) that satisfies the capabilities needed to produce the print object, as well as satisfying other requirements which may be associated with the user. Further, the server may provide a template associated with the print object to the user, allowing the user to customize the print object with, for example, specific content.

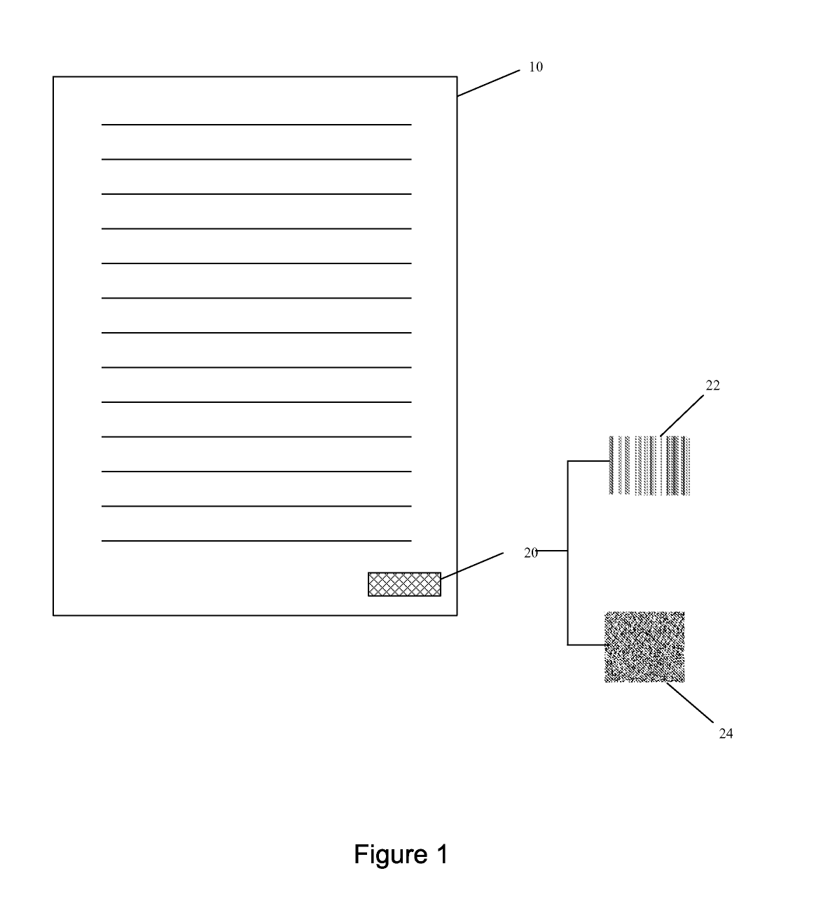

Various examples and their potential advantages are understood by referring to FIGS. 1-6 of the drawings.

FIG. 1 illustrates an example print object 10. The print object 10 may be produced by commercial print service providers and may include objects such as marketing materials, documents, photographs, advertisements, business cards, postcards, billboards. In other examples, the print object 10 may be produced by industrial print service providers and convertors and may include objects such as labels, packaging, cartons, flexible films or metallic films. In still other examples, the print object 10 may include objects generated from three-dimensional (3D) printers. In one example, the print object 10 may be a document which includes a multi-page report. The print object 10 may be associated with an identifier 20. The identifier 20 may be a part of the print object 10 or may be located proximate to the print object 10. In one example, the identifier 20 is located on one portion of the print object 10. For example, as illustrated in FIG. 1, the print object is positioned on a bottom margin of, for example, the cover page of the print object 10. In other examples, the identifier 20 may be positioned on the spine of a book, for example.

The identifier 20 may take any of a variety of forms. In one example, the identifier 20 takes the form of a machine readable representation that may be captured by, for example, a digital camera. For example, as illustrated in FIG. 1, the identifier 20 may take the form of visible marks such as a barcode 22 or a Quick Response (QR) code 24. In other examples, the identifier 20 may take the form of invisible marks such as a stegatone or may be formed using invisible inks such as UV inks In some examples, the identifier 20 may be a combination of visible and invisible marks. In other examples, any another machine readable representation of data may be used as the identifier 20.

As noted above, a user may capture, or scan, the identifier 20 with any of a variety of devices, such as a computer, a portable electronic device, or similar apparatus. In one example, the identifier 20 is captured using a digital camera on a communication device, such as a smart phone. The identifier 20 may be associated with the print object 10 and may contain certain information associated with the design and/or manufacturing of the print object 10. In one example, the identifier 20 includes a code which allows a server (described below) to access desired information related to the associated print object 10 from a database. In other examples, the identifier 20 may include information regarding print characteristics or capabilities associated with the print object 10, such as text-related information (e.g., font), layout, type of paper, type of ink, or printing device(s) used in production of the print object 20. In one example, the identifier 20 includes identification of one or more print service providers associated with the production of the print object 10.

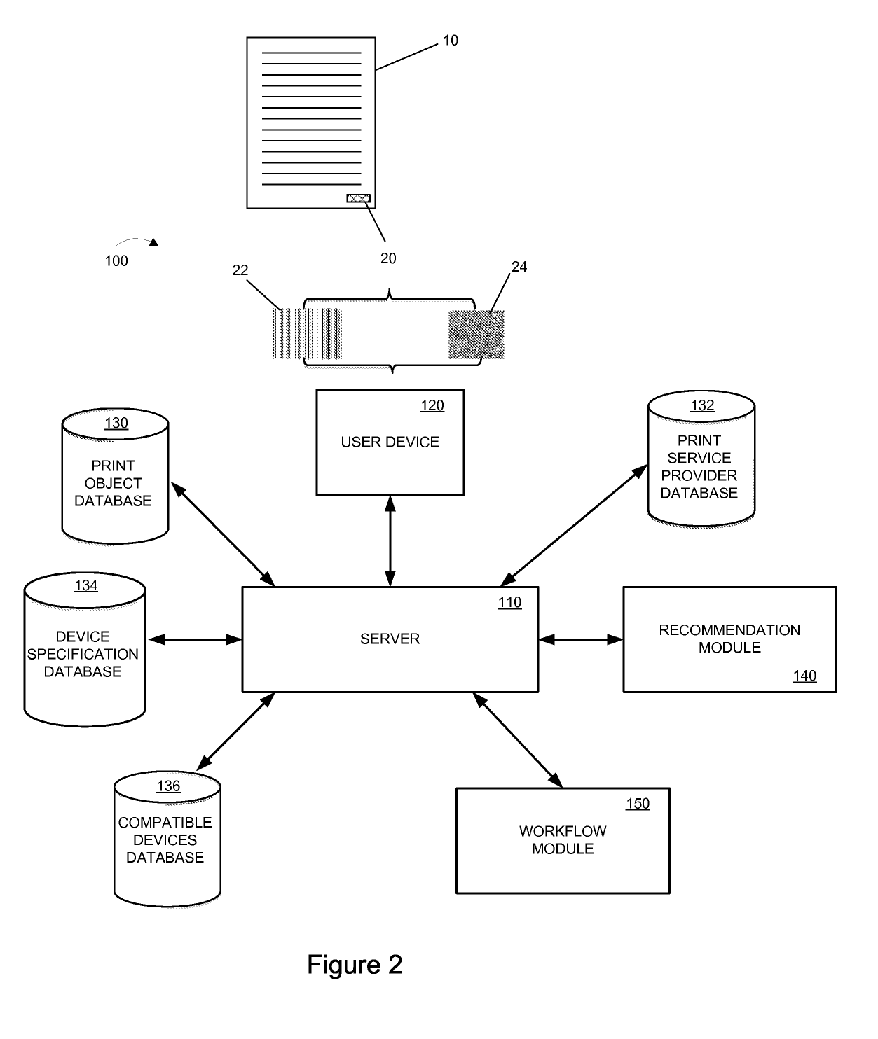

FIG. 2 illustrates an example print service system 100. The system 100 may include a server 110 configured to communicate with a user device 120. The user device may be any of a variety of devices capable of communication, such as wireless or wired communication. For example, the user device 120 may be a desktop computer, a laptop computer, a smart phone or a tablet. In one example, a user may scan an identifier 20 (e.g., barcode 22 or QR code 24) associated with the print object 10 with one device (e.g., digital camera) and communicate the identifier 20 to the server 110 using a second device (e.g., user device 120). In other examples, the user may use the user device 120 to capture the identifier 20 and to communicate the identifier 20 to the server 110. In one example, software used to scan the identifier 20 may initiate communication of the identifier to the server 110. For example, available QR readers may be configured to access the server 110 by the user device 120 based on a scan of a QR code 24.

The communication between the user device 120 and the server 110 may be achieved in a variety of manners. For example, the user device 120 may be a desktop computer connected to a public network, such as the Internet, through which it can access the server 110. In one example, the user device 120 is a smart phone and connects to the server 110 through the Internet, which the user device 120 may access through, for example, a cellular network.

The server 110 may be coupled to a variety of other components, such as one or more databases 130-136, a recommendation module 140, and a workflow module 150. In some examples, one or more of the components illustrated in FIG. 2 as being coupled to the server 110 may be embedded within the server 110. In some examples, one or more of the components may be remotely located and may communication with the server 110 through a network, such as the Internet. The one or more databases may include a print object database 130, a print service providers (PSP) database 132, a device specification database 134, and a compatible device specification database 136. The print object database 130 may include information associating various identifiers, such as identifier 20, with print objects, such as print object 10. In various examples, the print object database 130 may include a variety of information for each print object including, but not limited to, identity of a PSP which produced the print object, identification of equipment used to produce the print object, parameters set in the hardware and software used to produce the print object (e.g. press parameters, parameters in the RIP), identification of materials used to produce one or more portions (e.g., binding, cover, ink, etc.) of the print object, and a template associated with the print object. In this regard, a template may include formatting and various other information about the print object, but not include the printed content associated with the print object.

The PSP database 132 may include a variety of information related to various PSPs that, for example, are registered with the server 110. The PSP database 132 may include information such as the contact information of each PSP. The contact information may include the name of the PSP, a phone number, a fax number, an address, an email address, and a web address. In various examples, the PSP database 132 may also include information associated with the capabilities of each PSP. The capabilities may include, but not limited to, types of paper available from the PSP, types of equipment (e.g., model numbers of printing and finishing devices) used by the PSP, volume capacity handled by the PSP, price range for services, geographical location for print services, and delivery options available for print services (e.g., availability of same-day or overnight delivery).

A device specification database 134 may include characteristics associated with various types of printing and non-printing devices. In one example, the capabilities of various model numbers of devices, such as printing and finishing equipment may be included in the device specifications database 134. The capabilities associated with the equipment may include, for example, printing capacity, types of ink and papers supported by the device, etc.

The compatible device specification database 136 may include information associated with compatibility of devices used at various phases of the production process of the print object. For example, the compatible device specification database 136 may include a list of particular varnishes to be used in the finishing process that are compatible with various inks or printers used in the printing process. As a further example, the compatible device specification database 136 may include a list of compatible finishing equipments associated with a digital printing press.

It should be noted the information contained in the various databases 130, 132, 134, and 136 may overlap in some examples. Thus, the system 100 may comprise fewer or more databases than those illustrated in FIG. 2.

As noted above, a recommendation module 140 is coupled to the server 110. The recommendation module 140 may be configured to, based on information received from the user device 120 and/or information in the various databases 130-136, identify and/or recommend a PSP that may be suited to reproduce the print object 10 for the user. In one example, the recommendation includes the identity of one or more PSP's that may be options for the user.

In some examples, the system 100 may include a workflow module 150 configured to manage and/or monitor the production of a print object, for example. As illustrated in FIG. 2, the workflow module 150 is coupled to the server 110 and may, through the server, receive information associated with an order for a print object from the user device 120. In one example, the server 110 receives an order for a print object 10 from a user for a particular PSP and, through the workflow module 150, conveys the order to the desired PSP. The workflow module 150 may then monitor the workflow of the PSP for the order of the print object 10 through various steps of the production process. For example, the workflow module 150 may monitor and, in some examples, convey a status to the user, of the production process at order received, pre-press for the print object, printing content of the print object, application of a finish to the printed content, and completion and/or shipment of the print object. As noted above, in various examples, the work flow module 150 may be an embedded part of the server 110.

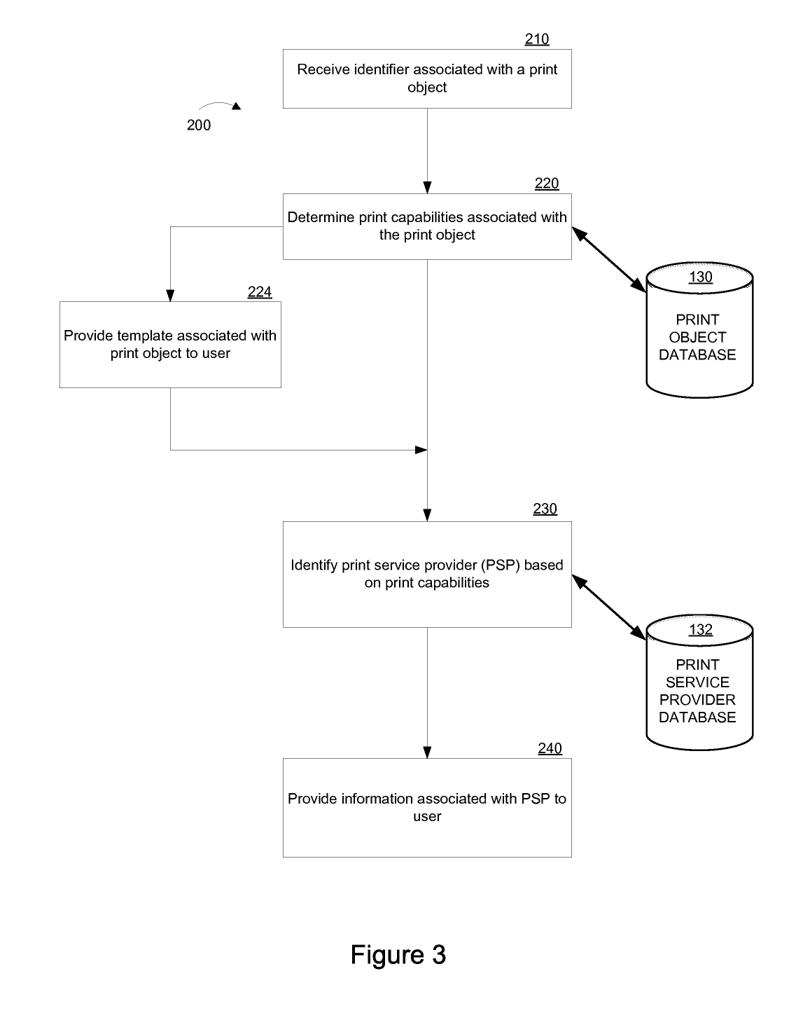

FIG. 3 illustrates a flowchart of an example process 200 for providing a print service. The process 200 may be facilitated by a computer system, such as the system 100 and the server 110 of FIG. 2, having, among other elements, a processor that carries out the instructions of a computer program and a memory device. In the example of FIG. 3, the process 200 begins with the receipt by, for example, the server 110 of an identifier 20 associated with a print object 10 from a user device 120 (block 210). The server may use the received identifier to determine the print capabilities associated with the production of the print object (block 220). In this regard, the server 110 may query the print object database 130. As noted above, the print object database 130 may contain, for example, information associating the print objects 10 with their respective identifiers 20. Further, as also noted above, the print object database 130 may include information such as identity of a PSP which produced the print object, identification of equipment used to produce the print object, identification of materials used to produce one or more portions (e.g., binding, cover, ink, etc.) of the print object, and a template associated with the print object.

The server 110 may query the PSP database 132 in order to identify a PSP that can reproduce the print object 10 (or the desired user print object) based on the information associated with the identifier 20 (block 230). As noted above, in certain cases, the identifier 20 may lead to identification of a particular PSP. In other cases, the server 110 or the recommendation module 140 may access the compatible devices database 136 and/or the device specification database 134 to identify a PSP which satisfies the capabilities associated with the identifier 20 received by the server 110. In some examples, if no PSP has the capability to reproduce a print object 10 satisfied the capabilities associated with the identifier 20, the server 110 or the recommendation module 140 may recommend substitutes for certain features of the print object 10. For example, if no PSP offers the specific type of ink identified for the print object 10 by the identifier 20, the server 110 or the recommendation module 140 may recommend an alternative ink or another print device that can be used for the closest reproduction of the print object 10. In some examples, the server 110 or the recommendation module 140 may recommend a PSP other that the one which produced the original print object 10 if, for example, the user lives outside the geographical region served by the PSP.

In some examples, the server 110 or the recommendation module 140 may recommend alternatives which may be preferable to the capabilities associated with the identifier. For example, a particular ink may provide a more cost-effective solution than the ink associated with the original print object 10. In another example, a superior alternative may be available based on the location of the user to those available to the producer of the original print object 10. Thus, in various examples, the server 110 or the recommendation module 140 may recommend alternatives even if all capabilities associated with the identifier are available.

In the illustrated example of FIG. 3, the server 110 or the recommendation module 140 may provide the user with the identity of a PSP that is appropriate, for example, to produce the print object (block 240). In this regard, information provided with the identity of the PSP may include the contact information of the PSP.

In some examples, the server 110 may provide a template of the print object 10 to the user (block 224). As noted above, the server 110 may obtain information including a template of the print object from the print object database 130. The template may include formatting, text information, paper and ink types, binding information and other such non-contextual information. In one example, the template includes options which allow the user to edit or insert text, graphics or other such contextual information. In one example, the print object 10 may be associated with several templates for the same print object 10, wherein each template includes a different number of fields or features that are changeable or determinable by the user. In some examples, the user may be charged for a template based on the number of fields or features that he can change or determine. In some examples, the user may specify certain print characteristics associated with a desired print object that are different from the characteristics associated with the identifier 20, such as the font and the type of paper. Such a user-edited template, including its specific characteristics, is referred to as the user print object. The server 110 may save the user print object, as may be dictated by the user, and may identify a PSP that satisfies the needs of the user print object.

Thus, a user may find out how a print object 10 was manufactured and locate a print service provider that can reproduce the print object 10, or another print object based on a template associated with the print object 10.

It is noted that the order of the steps illustrated in FIG. 3 may be varied in different examples. For example, the template may be provided to the user (block 224) at any point after the template is obtained from the print object database 130. For example, the template may be provided to the user after providing the user with the identity of the PSP.

In some examples, the system 100 may be configured to allow various entities to provide print objects and templates to the system. The entities, which may include users, PSP's, or designers, may indicate whether they allow sharing of the print objects or templates with other users. In some examples, the entities may allow sharing with a limited group of users, such as those associated with a certain organization, for example. As described below, the system 100 may allow for allocation of royalties to the original designer of a print object or template, as well as to those that contribute significant modifications. The print objects and templates provided by the entities may be stored in the system at, for example, the print object database 130.

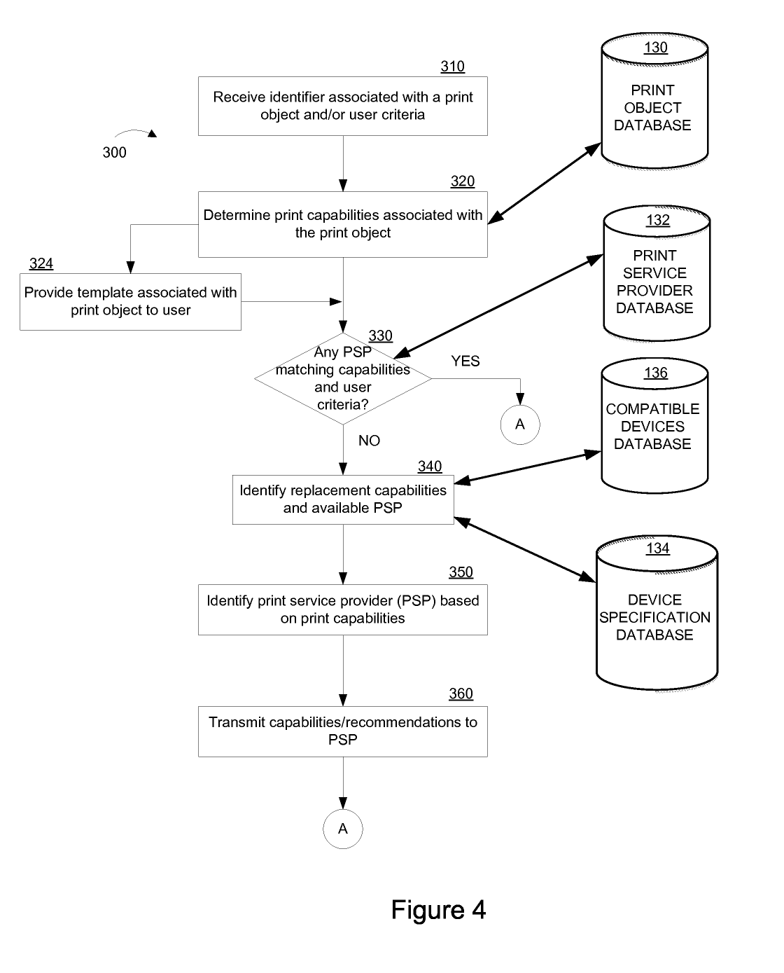

FIG. 4 illustrates a flowchart of another example process 300 for providing a print service. In the example of FIG. 4, the process 300 begins with the receipt by, for example, the server 110, of an identifier 20 associated with a print object 10 and/or various user criteria associated with the print object from a user device 120 (block 310). The server may use the received identifier to determine the print capabilities associated with the production of the print object (block 320). In this regard, the server 110 may query the print object database 130. As noted above, the print object database 130 may contain, for example, information associating the print objects 10 with their respective identifiers 20. Further, as also noted above, the print object database 130 may include information such as identity of a PSP which produced the print object, identification of equipment used to produce the print object, identification of materials used to produce one or more portions (e.g., binding, cover, ink, etc.) of the print object, and a template associated with the print object.

The user criteria may include, for example, a location of the user, special shipping requirements, etc.

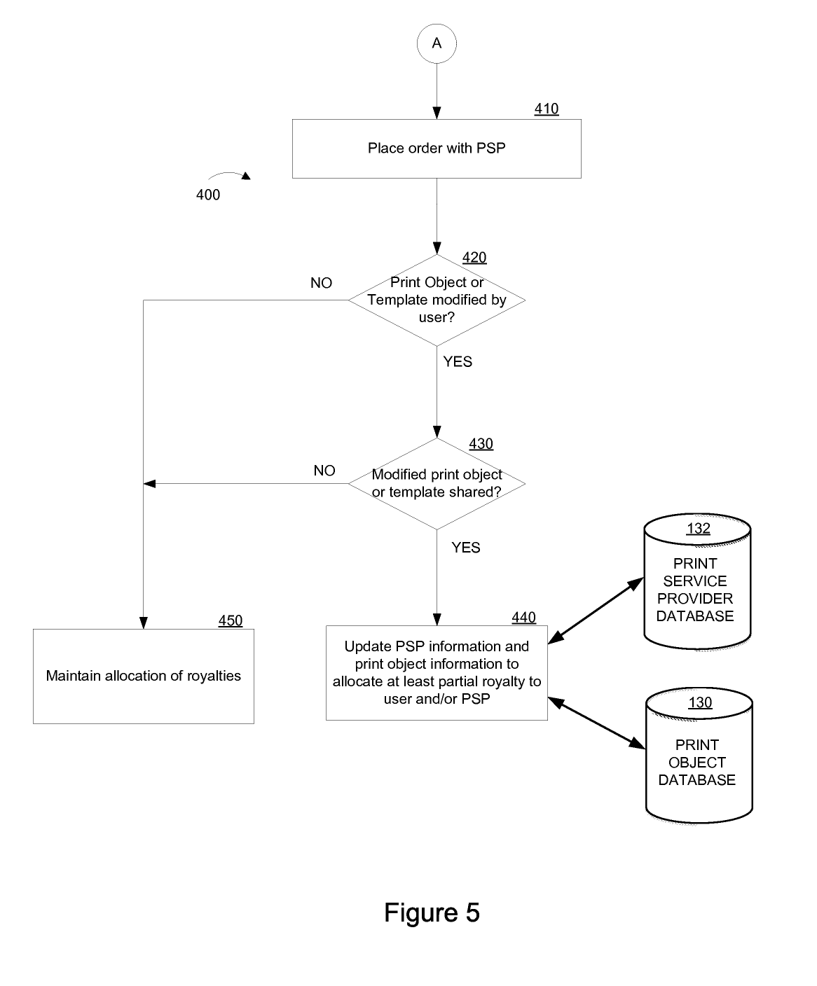

The server 110 may query the PSP database 132 in order to determine if any PSP can reproduce the print object 10 based on the information associated with the identifier 20 and/or the user criteria (block 330). As noted above, in certain cases, the identifier 20 may lead to identification of a particular PSP or a PSP which satisfies the capabilities associated with the identifier 20 received by the server 110. In such cases, the system may place an order to fulfill the request from the user or provide the PSP information to the user. In some examples, as described below with reference to FIG. 5, the system may proceed to allocate royalties.

As noted above, in some examples, the server 110 or the recommendation module 140 may provide the user with the identity of a PSP that is appropriate, for example to produce the print object. In this regard, information provided with the identity of the PSP may include the contact information of the PSP.

In some examples, as illustrated in FIG. 4, the server 110 may provide a template of the print object 10 to the user device 120 (block 324). The user may change or determine various sections of the template and may change or determine certain characteristics of the print object 10 to create a user print object that is saved for later processing. In some examples, the template and/or any changes to the template may be provided by the user as part of the user criteria described above.

In some examples, as described in FIG. 4, if no PSP satisfies the capabilities associated with the print object, the server 110 (e.g., through the recommendation module 140) may identify replacement capabilities in order to find an appropriate PSP (block 340). In this regard, the server 110 may access the compatible devices database 136 and the device specification database 134 to identify the replacement capabilities. The server may then identify a PSP that matches the replacement capabilities (block 350) and transmit the capabilities and/or recommendations, including an order for a user print object, to the selected PSP, for example (block 360).

As noted above, various examples of the system may allocate royalties, for example, for use of templates or print objects. A royalty portion may be allocated to the originator of the print object or template. In various examples, a royalty portion may be allocated to a user and/or PSP based on a modification to a print object or a template.

Referring now to FIG. 5, based on the process of FIG. 4, for example, the server 110 may place an order with a PSP according to a request by a user (block 410). A determination may be made as to whether the print object or the template was modified by the user (block 420). In this regard, the template or the print object may have been initially obtained by the user through the print object database 130, as described above with reference to block 324 of FIG. 4. If the determination is made that the print object or template was not modified by the user, the allocation of any royalties associated with the print object or template remains unchanged (block 450). Otherwise, a determination may be made as to whether the print object or template provided by the user is to be shared with other users (block 430). In this regard, a query may be submitted to the user and/or PSP asking for permission to share the print object and/or template in exchange for royalties, for example. In various examples, the user and/or PSP may be allowed to select from various levels of sharing. For example, the user or PSP may elect to share certain components of the print object or template, may allow varying levels of customization of the print object or template, or may allow sharing by a sub-group of users.

If the determination is made that the user and/or PSP does not allow sharing of the template or print object, the allocation of any royalties associated with the print object or template remains unchanged (block 450). Otherwise, the PSP information and print object information is updated to allocate at least part of the royalty for use of the template or print object to the user and/or PSP. In this regard, the server 110 may access the PSP database 132 and the print object database 130 to update or add the necessary information.

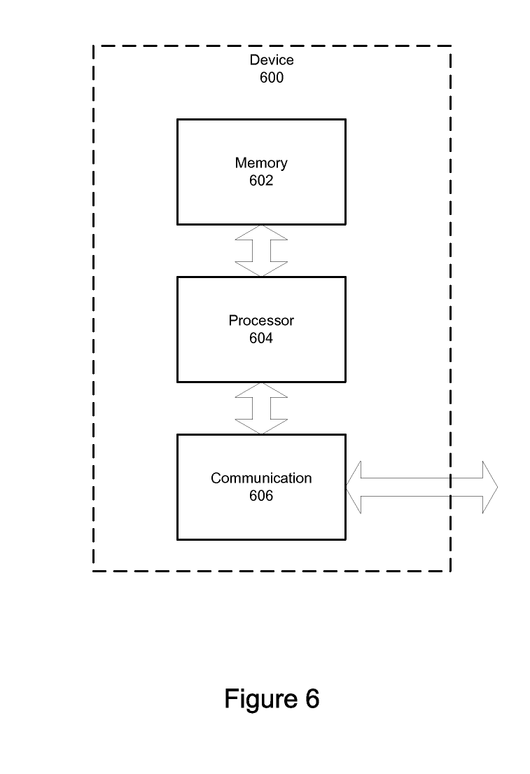

Referring now to FIG. 6, a block diagram of an example device 600 within which the various examples may be implemented is illustrated. The device 600 may be the server 110 of FIG. 2 or the user device, for example. The device 600 may include a processor 604 and/or controller, a memory 602 unit that is in communication with the processor 604, and a communication unit 606 that enables the exchange of data and information, directly or indirectly, with other entities, devices and networks. For example, the device 600 may be in communication with mobile devices, with a database or a server. The communication unit 606 may provide wired and/or wireless communication capabilities, through a communication link, in accordance with one or more communication protocols and, therefore, it may comprise the proper transmitter/receiver antennas, circuitry and ports, as well as the encoding/decoding capabilities that may be necessary for proper transmission and/or reception of data and other information.

The server may determine whether the user wishes to share the user print object with the PSP by, for example, asking the user through an inquiry to the user device 120 (block 326). If the user agrees to share the user print object, then royalties may be provided to the user (block 328). The royalties may be one time flat fees, discounts for services from the PSP, or other types of financial compensation to the user. In this regard, in some examples, either the PSP or the server 110 may track the royalties due to the user.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

Examples of the present disclosure may also comprise a computer system or similar device configured to access computer readable code or program instructions from a computer readable medium and to execute program instructions using one or more CPUs to carry out examples as described. Such computer system can be, but is not limited to a personal computer, a microcomputer, a handheld device, a network server, a telecommunications device, or a more advanced system such as a computer cluster, distributed computer system, server accessed over wired or wireless devices, a mainframe, or a supercomputer.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present invention and its practical application to enable one skilled in the art to utilize the present invention in various examples and with various modifications as are suited to the particular use contemplated. The features of the examples described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects are set out in the independent claims, other aspects comprise other combinations of features from the described examples and/or the dependent claims with the features of the independent claims, and not solely the combinations explicitly set out in the claims.

It is also noted herein that while the above describes examples, these descriptions should not be viewed in a limiting sense. Rather, there are several variations and modifications which may be made without departing from the scope as defined in the appended claims.

1. A method, comprising:
receiving a code associated with a machine-readable identifier captured by a user, the identifier being associated with a print object;
determining capabilities associated with the print object;
identifying a print service provider based on the capabilities; and
providing information associated with an identified print service provider to the user.

2. The method of claim 1, wherein the capabilities associated with the print object include information associated with at least one of the following: text, layout, font, type of paper, type of finishing material, types of ink, hardware or software used in production, or materials used in production.

3. The method of claim 1, wherein the information associated with the identified print service provider includes at least one of a name of the print service provider, an email address, a phone number, a fax number, an address, or a web address.

4. The method of claim 1, further comprising:
receiving an order from a user based on the print object, the order including an identified print service provider; and
determining whether the identified print service provider is an original producer of the print object.

5. The method of claim 4, further comprising:
if the identified print service provider is not an original producer of the print object, assigning a first royalty portion to an original producer of the print object and a second royalty portion to the identified print service provider; and
if the identified print service provider is the original producer of the print object, assigning the first royalty portion and the second royalty portion to the identified print service provider.

6. The method of claim 1, further comprising:
providing a template of the print object to the user.

7. The method of claim 6, further comprising:
receiving an order from a user for a user print object based on the print object, the order including an identified print service provider;
querying the user to share the user print object with the identified print service provider; and
if the user allows sharing of the user print object with the print service provider, assigning a royalty portion to the user for the user print object.

8. An apparatus, comprising:
a processor;
a memory coupled to said processor and including computer program code, the memory and the computer program code being configured to, with the processor, cause the apparatus to:
receive a code associated with a machine-readable identifier captured by a user, the identifier being associated with a print object;
use the code to access capabilities associated with the print object from a database;
identify a print service provider based on the capabilities; and
provide information associated with an identified print service provider to the user.

9. The apparatus of claim 8, wherein the capabilities associated with the print object include information associated with at least one of the following: text, layout, font, type of paper, type of finishing material, types of ink, hardware or software used in production, or materials used in production.

10. The apparatus of claim 8, wherein the information associated with the identified print service provider includes at least one of a name of the print service provider, an email address, a phone number, a fax number, an address, or a web address.

11. The apparatus of claim 8, wherein the memory and the computer program code are further configured to cause the apparatus to:
receiving an order from a user based on the print object, the order including an identified print service provider; and
determining whether the identified print service provider is an original producer of the print object.

12. The apparatus of claim 11, wherein the memory and the computer program code are further configured to cause the apparatus to:
if the identified print service provider is not an original producer of the print object, assigning a first royalty portion to an original producer of the print object and a second royalty portion to the identified print service provider; and
if the identified print service provider is the original producer of the print object, assigning the first royalty portion and the second royalty portion to the identified print service provider.

13. The apparatus of claim 8, wherein the memory and the computer program code are further configured to cause the apparatus to:
providing a template of the print object to the user.

14. The apparatus of claim 13, wherein the memory and the computer program code are further configured to cause the apparatus to:
receiving an order from a user for a user print object based on the print object, the order including an identified print service provider;
querying the user to share the user print object with the identified print service provider; and
if the user allows sharing of the user print object with the print service provider, assigning a royalty portion to the user for the user print object.

15. A system, comprising:
a server; and
one or more databases including information associated with print service capabilities,
wherein the server:
uses information associated with a machine-readable code captured by a user to identify a print object, determines capabilities associated with a print object and identifies a print service provider based on the information associated with print service capabilities in the one or more databases.
